(19) United States
(12) Patent Application Publication
(10) Pub. No.: US 2012/0132645 A1
(43) Pub. Date: May 31, 2012

(54) INDUCTION HEATER

(75) Inventors: Doo Yong Oh, Seoul (KR); Byeong Wook Park, Seoul (KR)

(73) Assignee: LG ELECTRONICS INC., Seoul (KR)

(21) Appl. No.: 13/318,042

(22) PCT Filed: Sep. 9, 2009
(86) PCT No.: PCT/KR2009/005117

§ 371 Date: Jan. 9, 2012

(30) Foreign Application Priority Data
May 4, 2009 (KR) 1020090038998

(51) Int. Cl. H05B 6/02

(52) U.S. Cl. 219/618

(57) ABSTRACT

The present invention comprises a grill unit which is heated by induction current. The grill unit comprises a grill which is heated by induction current, and a supporting unit is placed below the grill to store foreign matter falling from the grill. In addition, the grill unit is fixed to a heater main body by being coupled. The supporting unit comprises a coupling unit which is formed to be coupled with the heater main body. Additionally, the heater main body comprises a seat portion at one side, which is coupled to the coupling unit.

### TECHNICAL FIELD

The present invention relates an induction heater, and more particularly, to an induction heater heating a grill by induction current.

### BACKGROUND ART

In general, an induction heater is a device which induces electricity to flow through a cooking container made of metal using an electromagnetic force to heat the cooking container made of metal and has been widely applied in cooking appliances such as a radio oven, a rice cooker, an electric kettle and the like.

The induction heater generates the heat into the inside by using the electromagnetic force to heat the cooking container made of metal. Meanwhile, the induction heater is heated by placing or inserting the cooking container on or into to the upper side of the induction heater. However, the induction heater was not cooked by placing meat on the upper side without using the cooking container. In addition, there is a problem that since the upper side of a heater main body is formed by tempered glass, the appearance of the induction heater is contaminated by foreign matter produced from the meat when cooking by placing the meat and the like on the upper side.

### DISCLOSURE

### Technical Problem

The present invention has been made in an effort to solve the problems occurring in the prior art, and it is an object of the present invention to provide an induction heater to improve the thermal efficiency through the induced current.

### Technical Solution

In order to solve the aforementioned problem, there is provided an induction heater according to the present invention, including: a heater main body; an induction coil which included in the heater main body to form an electromagnetic field; and a grill unit which is disposed on one side of the heater body and heated by the electromagnetic field.

In addition, according to the present invention, the grill unit is formed to be attached and detached to or from the heater main body. Further, according to the present invention, the grill unit is heated by forming the induction current by the electromagnetic field formed by the induction coil.

### Advantageous Effects

The present invention includes an induction coil forming an electromagnetic field and a grill unit which is heated by the electromagnetic field through the induction coil. The thus-configured induction heater according to the present invention has the advantage capable of cooking meat without using the cooking container. In addition, since the grill unit is heated by the induced electric field and a separate power is not supplied to the grill unit, energy can be saved.

### DESCRIPTION OF DRAWINGS

FIG. 1 is an assembled perspective view illustrating an embodiment of an induction heater according to the present invention;

FIG. 2 is a sectional view taken along line A-A of FIG. 1;

FIG. 3 is a conceptual diagram illustrating the grill unit shown in FIG. 1;

FIG. 4 is a conceptual diagram illustrating operations of the grill unit shown in FIG. 3;

FIG. 5 is a perspective view illustrating the grill unit shown in FIG. 1; and

FIG. 6 is a cross-sectional view illustrating an embodiment of an assembly of a container seat portion of the grill unit shown in FIG. 1.

### BEST MODE

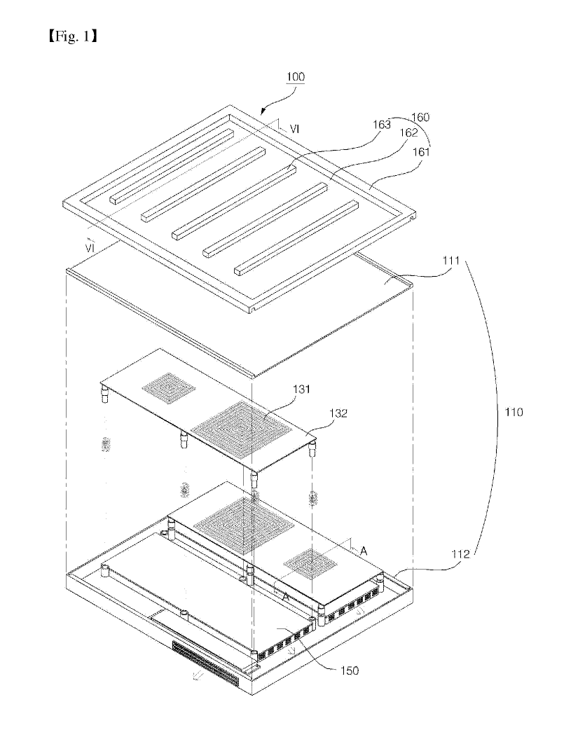

FIG. 1 is an assembled perspective view illustrating an embodiment of an induction heater 100 according to the present invention. FIG. 2 is a sectional view taken along line A-A of FIG. 1.

Referring to FIGS. 1 and 2, the induction heater 100 includes a heater main body 110; an induction coil 131 which included in the heater main body 110 to form an electromagnetic field; and a grill unit 160 which is disposed on one side of the heater body 110 and heated by the electromagnetic field. The heater main boy 110 includes a container seat portion 111 which is disposed on the upper side to place a cooking container (not shown), an induction coil base 132 which is disposed on the lower side of the container seat portion 111 to place the induction coil 131, a circuit unit 150 which is disposed on the lower side of the induction coil base 132 to control a current applied to the induction coil 131, and a body unit 112 on which the circuit unit 150 is disposed, which is coupled with the container seat portion 111.

Meanwhile, the induction coil base 132 is disposed to be spaced apart from the circuit unit 150 by a predetermined distance. A support unit 133 is disposed between the induction coil base 132 and the circuit unit 150 to support the induction coil base 132. The induction coil base 132 is formed with the induction coil 131 as described above. The induction coil 131 may be formed in various forms. That is, the induction coil 131 may be formed of a circular. In addition, the induction coil 131 may be formed into a rectangle shape or an elliptical shape. Hereinafter, for convenience of the description, it is mainly explained that the induction coil 131 is formed by the rectangle shape. However, the induction heater 100 according to the present invention is not limited to the following description, and may include all shapes of the induction coil 131. Meanwhile, the induction coil base 132 on which the induction coil 131 is formed by the rectangle shape, is disposed to be most closed to the container seat portion 111. When the induction coil base 132 is disposed to be closed to the container seat portion 111, heat generated from the induction coil 131 can be effectively delivered to the cooking container.

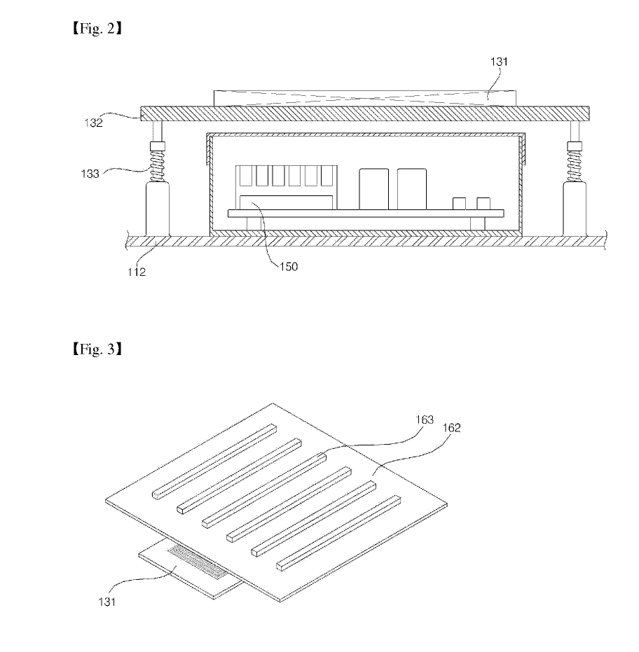

FIG. 3 is a conceptual diagram illustrating the grill unit 160 shown in FIG. 1; FIG. 4 is a conceptual diagram illustrating operations of the grill unit 160 shown in FIG. 3;

Referring to FIGS. 3 and 4, the grill unit 160 is disposed on the upper side of the container seat portion 111. The grill unit 160 includes a support unit 162 which is disposed on the one side of the heater main body 110 to collect foreign matter, and a grill 163 which is disposed on the upper side of the support unit 162 to be heated by the electromagnetic field. Meanwhile, one side of the heater main body 110 is formed with a seat portion 112 on which the grill unit 160 is placed and fixed. In addition, one side the grill unit 160 includes a coupling unit 161 coupled to the seat portion 112. The coupling unit 161 is formed on the one side of the support unit 162 and may be coupled to the seat portion 112. The coupling unit 161 and the seat portion 112 may be formed in the various forms. In addition, the coupling unit 161 may be formed to be corresponded to the seat portion 112. For example, the seat portion 112 may be formed in the shape of a guide. When the seat portion 112 is formed in the shape of the guide, the coupling unit 161 includes a guide groove to be corresponded to the guide. In addition, the seat portion 112 may be formed to include a fixing groove. When the seat portion 112 includes the fixing groove, the coupling unit 161 may include a fixing protrusion to be corresponded to the fixing groove. The seat portion 112 and the coupling unit 161 are not limited to the above- mentioned description, and all units and devices which couples such that the grill unit 160 is attached or detached to or from the heater main body 110, may be included.

Meanwhile, when the coupling unit 161 is placed on the seat portion 112, the grill unit 160 is disposed on the one side of the heater main body 110. In this case, when the user inputs the external signal from the outside through an input unit (not shown), the induction heater 100 is operated. When the induction heater 100 is operated, a current is applied to the induction coil 131. The induction coil 131 is heated by the applied current. In this case, the induction coil 131 is heated, and the electromagnetic field is formed by the current applied to the induction coil 131. The electromagnetic field is also formed on the upper side of the induction heater 100 by passing the container seat portion 111. The formed electromagnetic field will also affect the grill unit 160. In this case, the grill 163 may be formed of magnetic substances. In addition, the support unit 162 may include non-magnetic substances.

Looking at the process that the grill 163 is heated, a current is applied from the circuit unit 150 to the induction coil 131. In this case, the current is applied by converting AC supplied from a power source into DC. In addition, the current is applied by amplifying amplitude and the like while converting AC into DC. When the amplified current is supplied, the circuit unit 150 repeatedly supplies the current in turn such that an electromagnetic field is formed in the induction coil 131. Meanwhile, when the current amplified in the induction coil 131 is supplied in turn, the induction coil 131 is heated by a resistance of the induction coil 131. In addition, the electromagnetic field emitted from the induction coil 131 affects the grill 163. That is, when the electromagnetic field is emitted, the grill 163 formed by magnetic substances generates the induction current by the electromagnetic field. In this case, the induction current formed in the grill 163 is generated in both directions by successive iterations. The produced induction current is moved through the grill 163 by successive iterations and heat is generated by a resistance formed in the grill 163 member by itself. Meanwhile, since the support unit 162 is formed by non-magnetic substances, the induction current is not generated by the electromagnetic field. In addition, since the induction current is not generated, the support unit 162 is not heated. When the current applied to the induction coil 131 is rapidly increased, the induction current is rapidly increased so that the temperature of the grill 163 can be rapidly increased. Accordingly, the induction heater 100 according to the present invention may further include a temperature measuring unit (not shown) to measure the temperature of the induction coil 131. When the temperature measuring unit is further included, the induction heater 100 controls the current applied to the induction coil 131 according to the temperature of the induction coil 131 measured from the temperature measuring unit. That is, when the temperature of the induction coil 131 is increased, the current applied to the induction coil 131 is controlled to be low. In addition, when the temperature of the induction coil 131 is decreased, the current applied to the induction coil 131 is controlled to be high. Accordingly, the induction current formed in the grill 163 is controlled through the control. In addition, the temperature of the grill 163 is controlled by controlling the induction current. Accordingly, the user can cook foods through the grill 163 with a constant temperature.

Meanwhile, the user can cook by arranging meats and the like on the grill 163. That is, the user can operate the induction heater 100 through an input unit (not shown). When the induction heater 100 is operated, a current is applied to the induction coil 131, as described above. When the current is applied, the induction coil 131 forms the electromagnetic field to generate the induction current to the grill 163 by the electromagnetic field. When the induction current is generated, the grill 163 is heated by a self-resistance. Accordingly, the user can cook by placing meats on the grill 163. Meanwhile, when the user cooks by placing meats on the grill 163, foreign matter from the meats is discharged into the lower side. In this case, the foreign matter discharged from the lower side is stored in support unit 162. Accordingly, since the foreign matter is not dropped into the container seat portion 111, the user can cleanly maintain the induction heater 100. In addition, since the current is not directly supplied to the grill 163, the leakage current can be prevented.

FIG. is a perspective view illustrating the grill unit 160 shown in FIG. 1; FIG. 6 is a cross-sectional view illustrating an embodiment of an assembly of a container seat portion 111 of the grill unit 160 shown in FIG. 1.

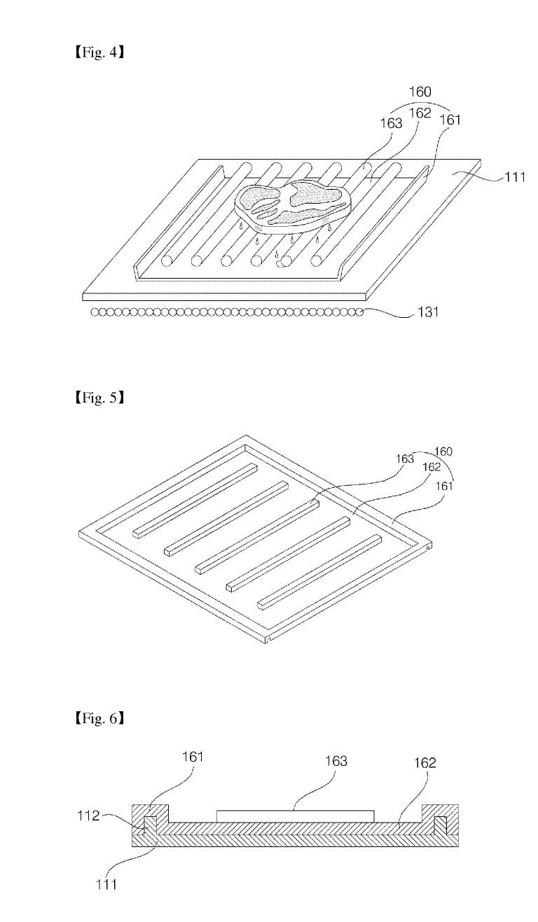

Referring to FIGS. 5 and 6, the grill unit 160 is disposed on the one side of the heater main body 110 to be placed on the heater main body 110. In this case, the grill 160 may be formed to be placed on the container seat portion 111. The grill unit 160 includes a support unit 162 which is disposed on the one side of the heater main body 110 to collect foreign matter, and a grill 163 which is disposed on the upper side of the support unit 162 to be heated by the electromagnetic field. Meanwhile, the container seat portion 111 is formed with a seat portion 112 on which the grill unit 160 is placed and fixed. In addition, the support unit 162 includes the coupling unit 161 to be coupled and fixed to the grill unit 160. Accordingly, the grill unit 160 can be effectively fixed to the container seat portion 111 by coupling or fixing the coupling unit 161 to the seat portion 112.

Looking at a process that the user places the grill unit 160 to the container seat portion 111, the user disposes the grill unit 160 to the upper side of the container seat portion 111. In this case, the user inserts and fixes the coupling unit 161 to the seat portion 112. The coupling unit 161 is formed to be corresponded to the seat portion 112 as described above. For example, when the seat portion 112 is formed in the shape of the guide, the coupling unit 161 is formed to include a guide groove. In this case, the user places the coupling unit 161 too the seat portion 112 and applies a force in the direction that the guide is formed. That is, the user places the guide on the guide groove and applies the force to the grill unit 160 in the direction that the guide is formed. When the force is applied to the grill unit 160, the grill unit 160 is moved in the guide direction. In this case, when the user continually applies the force to the grill unit 160, the grill unit 160 is exactly placed on the container seat portion 111. Accordingly, the user can easily use the grill unit 160 by disposing the grill unit 160 to the container seat portion 111. In addition, since the grill unit 160 can be easily attached or detached to or from the container seat portion 111, the user can easily cleans the grill unit 160.

Meanwhile, the coupling unit 161 and the seat portion 112 may be formed in the various forms, in addition to inclusion of the guide and the guide groove. That is, the coupling unit 161 may be formed by a fixing protrusion and the seat portion 112 may be formed to include a fixing protrusion groove on which the fixing protrusion is inserted and fixed. Accordingly, the coupling unit 161 and the seat portion 112 are not limited to the above-mentioned description and may be variously implemented. Thus, all structures and devices which place the grill unit 160 on the container seat portion 111 may be included.

1. An induction heater comprising:
a heater main body;
an induction coil which included in the heater main body to form an electromagnetic field; and
a grill unit which is coupled to be attached and detached to or from one side of the heater main body and heated by the electromagnetic field.

2. The induction heater of claim 1, wherein the grill unit is disposed on the upper side of the heater main body.

3. The induction heater of claim 1, wherein the grill unit includes a support unit which is disposed on the one side of the heater main body to collect foreign matter, and a grill which is disposed on the upper side of the support unit to be heated by the electromagnetic field.

4. The induction heater of claim 3, wherein the support unit includes non-magnetic substances

5. The induction heater of claim 3, wherein the grill includes magnetic substances

6. The induction heater of claim 1, wherein the grill unit generates the induction current by the electromagnetic field.

7. The induction heater of claim 1, wherein the induction coil is formed by a rectangle shape or an elliptical shape.

8. The induction heater of claim 1, wherein the induction heater includes a seat portion formed on one side of the heater main body to place and to fix the grill unit.

9. The induction heater of claim 8, wherein the induction heater includes a coupling unit formed on the one side of the grill unit to be corresponded to the seat portion to be coupled to the seat portion.

10. The induction heater of claim 1, further comprising:
a temperature measuring unit for measuring a temperature of the induction coil, a current applied to the induction coil is controlled based on the temperature of the induction coil measured from the temperature measuring unit.
